(19) United States
(12) Patent Application Publication
(10) Pub. No.: US 2025/0283015 A1
(43) Pub. Date: Sep. 11, 2025

(54) CLEANING BOOSTER

(71) Applicants: Dow Global Technologies LLC, Midland, MI (US); Rohm and Haas Company, Collegeville, PA (US)

(72) Inventors: Aslin Izmitli, Spring City, PA (US); Randara Pulukkody, Lansdale, PA (US); Michael Tulchinsky, Midland, MI (US); Eric Wasserman, Collegeville, PA (US)

(21) Appl. No.: 18/857,201

(22) PCT Filed: Jun. 14, 2023
(86) PCT No.: PCT/US2023/025233

§ 371 Date: Oct. 16, 2024

Related U.S. Application Data
(60) Provisional application No. 63/353,031, filed on Jun. 17, 2022.

(51) Int. Cl. C11D 3/37

(52) U.S. Cl. CPC C11D 3/3707; C11D 2111/12

(57) ABSTRACT

Cleaning booster for cleaning dirty laundry is provided, wherein the cleaning booster is of formula (I) wherein A¹ is a divalent linking group having 4 to 24 carbon atoms and R¹ is of formula (II), formula (III) or formula (IV); wherein * is the point of attachment to formula (I); a is 1-2; b is 1-2; and R² is of formula (V); wherein * is the point of attachment to the associated base formula; R³ is selected from hydrogen and C₁₋₂₂ alkyl group; R⁴ and R⁵ are independently selected from hydrogen and C₁₋₂ alkyl group, with the proviso that at least one of R⁴ and R⁵ is hydrogen in each subunit c; and wherein c is 0-30; and with the proviso that when the divalent linking group, A¹, has 4 carbon atoms, the divalent linking group, A¹, includes a cycle.

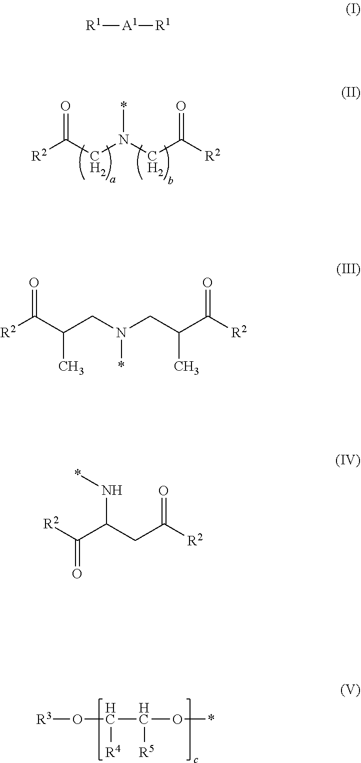

The present invention relates to a cleaning booster for cleaning dirty laundry. In particular, the present invention relates to a cleaning booster for cleaning dirty laundry, wherein the cleaning booster is of formula (I)

R¹-A¹-R¹ (I)

wherein A¹ is a divalent linking group having 4 to 24 carbon atoms; and wherein each R¹ is independently selected from the group consisting of formula (II), formula (III) and formula (IV)

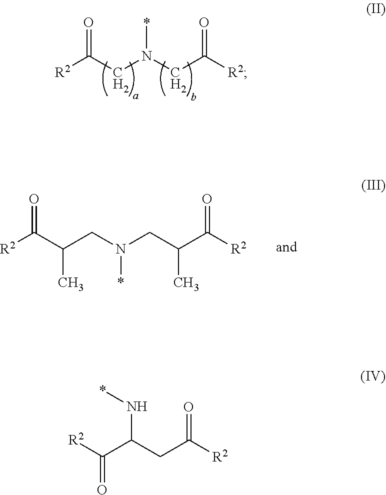

wherein the * in formula (II), formula (III) and formula (IV) is the point of attachment to formula (I); wherein a is 1 or 2; wherein b is 1 or 2; and wherein each R² is independently of formula (V)

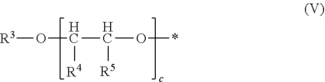

wherein the * in formula (V) is the point of attachment to the associated base formula; wherein R³ is selected from the group consisting of a hydrogen and a C₁₋₂₂ alkyl group; wherein each R⁴ and R⁵ is independently selected from the group consisting of a hydrogen and a C₁₋₂ alkyl group, with the proviso that at least one of R⁴ and R⁵ is a hydrogen in each subunit c; and wherein c is 0 to 30; and with the proviso that when the divalent linking group, A¹, has 4 carbon atoms, the divalent linking group, A¹, includes a cycle.

One approach for reducing the unit dose of surfactant is to incorporate polymers into the liquid detergent formulations as described by Boutique et al. in U.S. Patent Application Publication No. 20090005288. Boutique et al. disclose a graft copolymer of polyethylene, polypropylene or polybutylene oxide with vinyl acetate in a weight ratio of from about 1:0.2 to about 1:10 for use in liquid or gel laundry detergent formulations having about 2 to about 20 wt % surfactant.

Notwithstanding, there remains a continuing need for cleaning boosters that facilitate maintained primary cleaning performance with reduced surfactant loading laundry detergent formulations (particularly in liquid or gel laundry detergent formulations and unit dose formulations); preferably, while also providing improved anti-redeposition performance. There is also a continuing need for new cleaning boosters with improved biodegradability according to OECD 301F protocol when compared with conventional cleaning boosters.

The present invention provides a cleaning booster for cleaning dirty laundry, wherein the cleaning booster is of formula (I)

R¹-A¹-R¹ (I)

wherein A¹ is a divalent linking group having 4 to 24 carbon atoms; and wherein each R¹ is independently selected from the group consisting of formula (II), formula (III) and formula (IV)

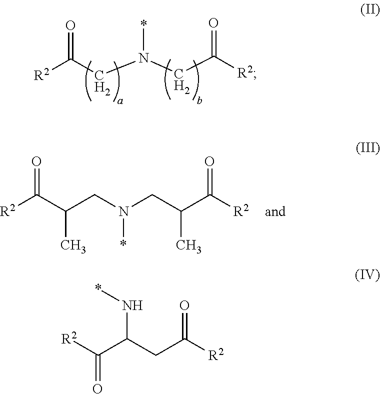

wherein the * in formula (II), formula (III) and formula (IV) is the point of attachment to formula (I); wherein a is 1 or 2; wherein b is 1 or 2; and wherein each R² is independently of formula (V)

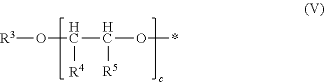

wherein the * in formula (V) is the point of attachment to the associated base formula; wherein R³ is selected from the group consisting of a hydrogen and a C₁₋₂₂ alkyl group; wherein each R⁴ and R⁵ is independently selected from the group consisting of a hydrogen and a C₁₋₂ alkyl group, with the proviso that at least one of R⁴ and R⁵ is a hydrogen in each subunit c; and wherein c is 0 to 30; and with the proviso that when the divalent linking group, A¹, has 4 carbon atoms, the divalent linking group, A¹, includes a cycle.

The present invention provides a cleaning booster for cleaning dirty laundry, wherein the cleaning booster is of formula (Ia)

R¹—(CH₂)ₙ—R¹ (Ia)

wherein n is 5 to 24; and wherein each R¹ is independently selected from the group consisting of formula (II), formula (III) and formula (IV); wherein the * in formula (II), formula (III) and formula (IV) is the point of attachment to formula (I); wherein a is 1 or 2; wherein b is 1 or 2; and wherein each R² is independently of formula (V); wherein the * in formula (V) is the point of attachment to the associated base formula; wherein R³ is selected from the group consisting of a hydrogen and a C₁₋₂₂ alkyl group; wherein each R⁴ and R⁵ is independently selected from the group consisting of a hydrogen and a C₁₋₂ alkyl group, with the proviso that at least one of R⁴ and R⁵ is a hydrogen in each subunit c; and wherein c is 0 to 30; and with the proviso that when the divalent linking group, A¹, has 4 carbon atoms, the divalent linking group, A¹, includes a cycle.

The present invention provides a cleaning booster for cleaning dirty laundry, wherein the cleaning booster is of formula (Ib)

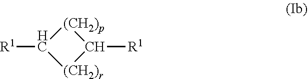

wherein p and r are independently 1 to 4; and wherein each R¹ is independently selected from the group consisting of formula (II), formula (III) and formula (IV); wherein the * in formula (II), formula (III) and formula (IV) is the point of attachment to formula (I); wherein a is 1 or 2; wherein b is 1 or 2; and wherein each R² is independently of formula (V); wherein the * in formula (V) is the point of attachment to the associated base formula; wherein R³ is selected from the group consisting of a hydrogen and a C₁₋₂₂ alkyl group; wherein each R⁴ and R⁵ is independently selected from the group consisting of a hydrogen and a C₁₋₂ alkyl group, with the proviso that at least one of R⁴ and R⁵ is a hydrogen in each subunit c; and wherein c is 0 to 30; and with the proviso that when the divalent linking group, A¹, has 4 carbon atoms, the divalent linking group, A¹, includes a cycle.

The present invention provides a cleaning booster for cleaning dirty laundry, wherein the cleaning booster is of formula (Ic)

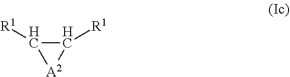

wherein A² is a divalent linking group having 2 to 22 carbon atoms; and wherein each R¹ is independently selected from the group consisting of formula (II), formula (III) and formula (IV); wherein the * in formula (II), formula (III) and formula (IV) is the point of attachment to formula (I); wherein a is 1 or 2; wherein b is 1 or 2; and wherein each R² is independently of formula (V); wherein the * in formula (V) is the point of attachment to the associated base formula; wherein R³ is selected from the group consisting of a hydrogen and a C₁₋₂₂ alkyl group; wherein each R⁴ and R⁵ is independently selected from the group consisting of a hydrogen and a C₁₋₂ alkyl group, with the proviso that at least one of R⁴ and R⁵ is a hydrogen in each subunit c; and wherein c is 0 to 30; and with the proviso that when the divalent linking group, A¹, has 4 carbon atoms, the divalent linking group, A¹, includes a cycle.

The present invention provides a cleaning booster for cleaning dirty laundry, wherein the cleaning booster is of formula (Id)

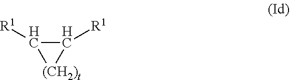

wherein t is 2 to 10; and wherein each R¹ is independently selected from the group consisting of formula (II), formula (III) and formula (IV); wherein the * in formula (II), formula (III) and formula (IV) is the point of attachment to formula (I); wherein a is 1 or 2; wherein b is 1 or 2; and wherein each R² is independently of formula (V); wherein the * in formula (V) is the point of attachment to the associated base formula; wherein R³ is selected from the group consisting of a hydrogen and a C₁₋₂₂ alkyl group; wherein each R⁴ and R⁵ is independently selected from the group consisting of a hydrogen and a C₁₋₂ alkyl group, with the proviso that at least one of R⁴ and R⁵ is a hydrogen in each subunit c; and wherein c is 0 to 30; and with the proviso that when the divalent linking group, A¹, has 4 carbon atoms, the divalent linking group, A¹, includes a cycle.

The present invention provides a laundry additive comprising a mixture of a cleaning booster of the present invention and water.

### DETAILED DESCRIPTION

It has been surprisingly found that the cleaning boosters as described herein facilitate improvement in primary cleaning performance for sebum soil removal, while imparting good anti-redeposition performance for dust sebum and clay and also exhibiting desirable biodegradability profiles according to OECD 301F protocol.

Preferably, the cleaning booster for cleaning dirty laundry, of the present invention, is of formula (I) (preferably, wherein formula (I) is selected from the group consisting of formula (Ia), formula (Ib), formula (Ic) and formula (Id) (preferably, formula (Ia) and formula (Ib))

R¹-A¹-R¹ (I)

wherein A¹ is a divalent linking group having 4 to 24 carbon atoms (preferably, wherein the divalent linking group, A¹, is a divalent cyclic or acyclic, linear or branched, aliphatic hydrocarbon having 4 to 24 carbon atoms (preferably, 4 to 12 carbon atoms)); and wherein each R¹ is independently selected from the group consisting of formula (II), formula (III) and formula (IV) (preferably, formula (II) and formula (III); most preferably, formula (III))

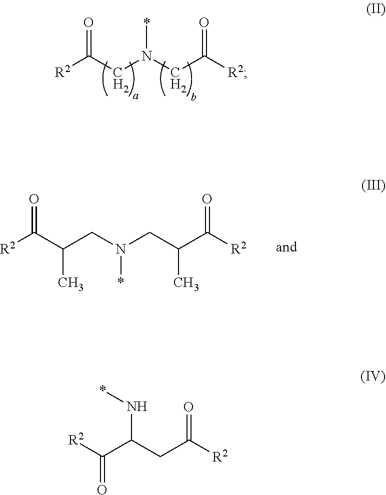

wherein the * in formula (11), formula (111) and formula (IV) is the point of attachment to formula (I); wherein a is 1 or 2 (preferably, 1); wherein b is 1 or 2 (preferably, 1); (preferably, wherein a=b) and wherein each R² is independently of formula (V) (i.e., the individual occurrences of R² in formula (II), formula (III) and formula (IV) can be the same or different from one another)

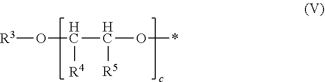

wherein the * in formula (V) is the point of attachment to the associated base formula (i.e., formula (II), formula (III) or formula (IV)); wherein R³ is selected from the group consisting of a hydrogen and a C₁₋₂₂ alkyl group (preferably, a hydrogen and a C₁₋₅ alkyl group; more preferably, a methyl group, an ethyl group and a butyl group; still more preferably, a methyl group and an n-butyl group; most preferably, an n-butyl group); wherein each R⁴ and R⁵ is independently selected from the group consisting of a hydrogen and a C₁₋₂ alkyl group, with the proviso that at least one of R⁴ and R⁵ is a hydrogen in each subunit c; and wherein c is 0 to 30 (preferably, with the proviso that c is 2 to 30 (preferably, 2 to 25; more preferably, 2 to 17; most preferably, 4 to 12) in 70 to 100 mol % (preferably, 80 to 100 mol %; more preferably, 90 to 100 mol %; most preferably, 95 to 100 mol %) of the occurrences of formula (V) in the cleaning booster); and with the proviso that when the divalent linking group, A¹, has 4 carbon atoms, the divalent linking group, A¹, includes a cycle (preferably, with the proviso that when the divalent linking group, A¹, has 4 carbon atoms, the cleaning booster of formula (I) is selected from the group consisting of formula (Ib), formula (Ic) and formula (Id)).

Preferably, the cleaning booster for cleaning dirty laundry of the present invention is of formula (I); wherein formula (I) is selected from the group consisting of formula (La), formula (Tb), formula (Ic) and formula (Id) (preferably, formula (Ta) and formula (Ib))

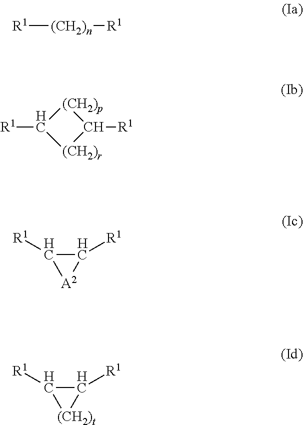

wherein n is 5 to 24 (preferably, 5 to 12); wherein p and r are independently 1 to 4 (preferably, 1 to 2; more preferably, wherein p and r are 2)(preferably, wherein the sum of p+r is 2 to 6 (preferably, 2 to 5; more preferably, 4)); wherein A² is a divalent linking group having 2 to 22 carbon atoms (preferably, wherein the divalent linking group, A², is a divalent, cyclic or acyclic, linear or branched, aliphatic hydrocarbon having 2 to 22 carbon atoms (preferably, 2 to 10 carbon atoms; more preferably, 3 to 6 carbon atoms; most preferably, 4 carbon atoms); more preferably, wherein the divalent linking group, A², is an alkanediyl having 2 to 22 carbon atoms (preferably, 2 to 10 carbon atoms; more preferably, 3 to 6 carbon atoms; still more preferably, 3 to 5; most preferably, 4 carbon atoms)); and wherein t is 2 to 10 (preferably, 3 to 6; more preferably, 3 to 5; most preferably, 4).

Preferably, the cleaning booster for cleaning dirty laundry of the present invention is of formula (I) (preferably, wherein formula (I) is selected from the group consisting of formula (Ia), formula (Ib), formula (Ic) and formula (Id) (preferably, formula (Ia) and formula (Ib)); wherein each R¹ is independently selected from the group consisting of formula (II), formula (III) and formula (IV) (preferably, formula (II) and formula (III); most preferably, formula (III))

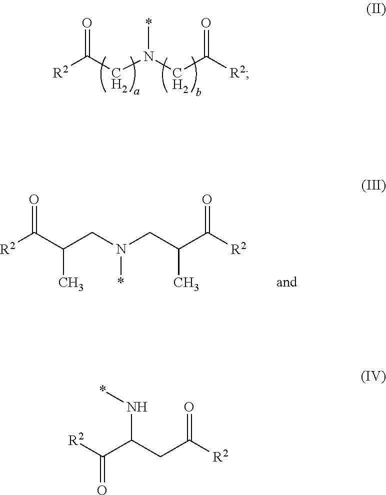

wherein the * in formula (II), formula (III) and formula (IV) is the point of attachment to formula (I); wherein a is 1 or 2 (preferably, 1); wherein b is 1 or 2 (preferably, 1); (preferably, wherein a=b) and wherein each R² is independently of formula (V) (i.e., the individual occurrences of R² in formula (II), formula (III) and formula (IV) can be the same or different from one another);

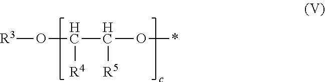

wherein the * in formula (V) is the point of attachment to the associated base formula (i.e., formula (II), formula (III) or formula (IV)); wherein R³ is selected from the group consisting of a hydrogen and a C₁₋₂₂ alkyl group (preferably, a hydrogen and a C₁₋₅ alkyl group; more preferably, a methyl group, an ethyl group and a butyl group; still more preferably, a methyl group and an n-butyl group; most preferably, an n-butyl group); wherein each R⁴ and R⁵ is independently selected from the group consisting of a hydrogen and a C₁₋₂ alkyl group, with the proviso that at least one of R⁴ and R⁵ is a hydrogen in each subunit c; and wherein c is 0 to 30 (preferably, with the proviso that c is 2 to 30 (preferably, 2 to 25; more preferably, 2 to 17; most preferably, 4 to 12) in 70 to 100 mol % (preferably, 80 to 100 mol %; more preferably, 90 to 100 mol %; most preferably, 95 to 100 mol %) of the occurrences of formula (V) in the cleaning booster).

Preferably, the cleaning booster for cleaning dirty laundry of the present invention is of formula (I) (preferably, wherein formula (I) is selected from the group consisting of formula (Ia), formula (Ib), formula (Ic) and formula (Id) (preferably, formula (Ia) and formula (Tb)); wherein cis 2 to 30 for an average of 70 to 100 mol % (preferably, 80 to 100 mol %; more preferably, 90 to 100 mol %; most preferably, 95 to 100 mol %) of the R² groups of formula (V). More preferably, the cleaning booster for cleaning dirty laundry of the present invention is of formula (I) (preferably, wherein formula (I) is selected from the group consisting of formula (Ia), formula (Ib), formula (Ic) and formula (Id) (preferably, formula (Ia) and formula (Ib)); wherein an average of 70 to 100 mol % (preferably, 80 to 100 mol %; more preferably, 90 to 100 mol %; most preferably, 95 to 100 mol %) of the R² groups of formula (V) are of formula (Va)

R⁶—O—|CH₂CH(R⁷)O|_{y}—* (Va)

wherein the * in formula (Va) is the point of attachment to the associated base formula (i.e., formula (II), formula (III) or formula (IV)); wherein R⁶ is selected from the group consisting of a hydrogen and a C₁₋₂₂ alkyl group (preferably, a hydrogen and a C₁₋₅ alkyl group; more preferably, a methyl group, an ethyl group and a butyl group; still more preferably, a methyl group and an n-butyl group; most preferably, an n-butyl group); wherein each R⁷ is independently selected from the group consisting of a hydrogen and a C₁₋₂ alkyl group; and wherein y is 2 to 30. Most preferably, the cleaning booster for cleaning dirty laundry of the present invention is of formula (I) (preferably, wherein formula (I) is selected from the group consisting of formula (Ia), formula (Ib), formula (Ic) and formula (Id) (preferably, formula (Ia) and formula (Ib)); wherein an average of 70 to 100 mol % (preferably, 80 to 100 mol %; more preferably, 90 to 100 mol %; most preferably, 95 to 100 mol %) of the R² groups of formula (V) are of formula (Vb)

R⁸—O-(EO)ₕ—(PO)ᵢ-(EO)ⱼ—* (Vb)

wherein the * in formula (Vb) is the point of attachment to the associated base formula (i.e., formula (II), formula (III) or formula (IV)); wherein R⁸ is selected from the group consisting of a hydrogen and a C₁₋₂₂ alkyl group (preferably, a hydrogen and a C₁₋₅ alkyl group; more preferably, a methyl group, an ethyl group and a butyl group; still more preferably, a methyl group and an n-butyl group; most preferably, an n-butyl group); wherein EO is an ethylene oxide group; wherein PO is a propylene oxide group; wherein h is 0 to 30 (preferably, 0 to 1); wherein i is 0 to 30 (preferably, 2 to 5); wherein j is 0 and 30 (preferably, 2 to 6); and wherein h+i+j is 2 to 30 (preferably, 4 to 12).

Preferably, the laundry additive of the present invention comprises a mixture of a cleaning booster of the present invention and water. More preferably, the laundry additive of the present invention is a mixture comprising 0.1 to 99 wt % (preferably, 0.2 to 98 wt %; more preferably, 0.5 to 95 wt %; most preferably, 0.75 to 90 wt %), based on weight of the laundry additive, of a cleaning booster of the present invention; and 1 to 99.9 wt % (preferably, 2 to 99.8 wt %; more preferably, 5 to 99.5 wt %; most preferably, 10 to 99.25 wt %), based on weight of the laundry additive, of water. Most preferably, the laundry additive of the present invention is a mixture comprising 0.1 to 99 wt % (preferably, 0.2 to 98 wt %; more preferably, 0.5 to 95 wt %; most preferably, 0.75 to 90 wt %), based on weight of the laundry additive, of a cleaning booster of the present invention; and 1 to 99.9 wt % (preferably, 2 to 99.8 wt %; more preferably, 5 to 99.5 wt %; most preferably, 10 to 99.25 wt %), based on weight of the laundry additive, of water; wherein the laundry additive is a liquid (preferably, wherein the laundry additive is a liquid at 21° C. and 1 standard atmosphere of pressure).

Some embodiments of the present invention will now be described in detail in the following Examples.

### Synthesis S1: Michael Addition of 1,3-Diaminopropane to Dimethyl Maleate

A 250 mL 3-necked, glass, round bottom flask equipped with a magnetic stir bar was charged with 1,3-diaminopropane (15.217 g, 202 mmol, from TCI America >98.0%) and ethanol (64 mL). Gentle mixing was initiated, and the flask was equipped with a cold-water condenser connected to an oil bubbler. The condenser was sealed to the center neck with silicone grease and the flask was further sealed with 2 rubber septa. The flask was then cooled by submerging in an ice water bath to absorb the heat of reaction. A thermocouple was inserted into one septum to track temperature during reaction. To the contents of the flask was slowly added dimethyl maleate (60.263 g, 404 mmol, from TCI America 97%) via a syringe over 22 minutes. A large exotherm was observed during the addition of dimethyl maleate. Once the temperature had stopped increasing, the flask was then placed on a reaction block heater and stirred at 60° C. for 4.5 hours. Progress of the reaction was monitored by ¹H and ¹³C NMR spectroscopy. Upon complete conversion of amine to disubstituted adduct, ethanol was distilled off in a rotary evaporator to yield a slightly viscous light yellow adduct. ¹H NMR (500 MHz, methanol-d₄) δ 3.75 (s, 6H), 3.70 (s, 6H), 2.74 (m, 6.5H), 2.58 (m, 2.3H), 1.65 (p, 2.2H), 1.3 (m, 1H); ¹³C NMR (500 MHz, CDCl₃) δ: 175.1 (2C), 172.8 (2C), 58.7 (1C), 58.6 (1C); 52.6 (2C), 52.3 (2C), 47.2 (1C), 47.0 (1C), 38.2 (1C) 38.1 (1C).

### Synthesis S2: Michael Addition of 1,6-Diaminohexane to Dimethyl Maleate

A 100 mL 3-necked, glass, round bottom flask equipped with a magnetic stir bar was charged with 1,6-diaminohexane (1.776 g, 15.1 mmol, from Sigma Aldrich ≥99%) and ethanol (16 mL). Gentle mixing was initiated, and the flask was equipped with a cold-water condenser connected to an oil bubbler. The condenser was sealed to the center neck with silicone grease and the flask was further sealed with 2 rubber septa. The flask was then cooled by submerging in an ice water bath to absorb the heat of reaction. A thermocouple was inserted into one septum to track temperature during reaction. To the contents of the flask was slowly added dimethyl maleate (4.445 g, 29.9 mmol, from TCI America 97%) via a syringe over 2 minutes. An exotherm was observed during the addition of dimethyl maleate and 3 minutes after. Once the temperature had stopped increasing, the flask was then placed on a reaction block heater and stirred at 60° C. for 7 hours. Progress of the reaction was monitored by ¹H and ¹³C NMR spectroscopy. Upon complete conversion of amine to disubstituted adduct, ethanol was distilled off in a rotary evaporator to yield a slightly viscous light yellow adduct. ¹H NMR (500 MHz, CDCl₃) δ 3.65 (s, 6H), 3.60 (s, 7H), 3.58-3.48 (m, 2H), 2.64 (dd, J=15.8, 6.0 Hz, 2H), 2.59-2.47 (m, 5H), 2.40 (ddd, J=11.1, 7.9, 6.3 Hz, 2H), 1.35 (p, J=6.2 Hz, 5H), 1.28-1.06 (m, 7H).; ¹³C NMR (500 MHz, CDCl₃) δ: 174.1 (2C), 171.2 (2C), 57.6 (2C), 52.2 (2C), 51.7 (2C), 47.9 (2C), 37.7 (2C), 29.9 (2C), 26.9 (2C).

### Synthesis S3: Michael Addition of 1,12-Diaminododecane to Dimethyl Maleate

A 250 mL 3-necked, glass, round bottom flask equipped with a magnetic stir bar was charged with 1,12-diaminododecane (6.861 g, 34.2 mmol, from TCI America 99.8%) and ethanol (32 mL). Gentle mixing was initiated, and the flask was equipped with a cold-water condenser connected to an oil bubbler. The condenser was sealed to the center neck with silicone grease and the flask was further sealed with 2 rubber septa. The flask was then cooled by submerging in an ice water bath to absorb the heat of reaction. A thermocouple was inserted into one septum to track temperature during reaction. To the contents of the flask was slowly added dimethyl maleate (10.148 g, 68.3 mmol, from TCI America 97%) via a syringe over 7 minutes. An exothermic event was observed during the addition of dimethyl maleate and 4 minutes after. Once the temperature had stopped increasing, the flask was then placed on a reaction block heater and stirred at 60° C. for 4 hours. Progress of the reaction was monitored by ¹H and ¹³C NMR spectroscopy. Upon complete conversion of amine to disubstituted adduct, ethanol was distilled off in a rotary evaporator to yield a slightly viscous light yellow adduct. ¹H NMR (500 MHz, CDCl₃) δ 3.64 (s, 6H), 3.59 (s, 6H), 3.61-3.50 (m, 3H), 2.63 (dd, J=15.8, 6.1 Hz, 2H), 2.60-2.49 (m, 5H), 2.39 (ddd, J=11.1, 8.0, 6.3 Hz, 2H), 1.41-1.28 (m, 5H), 1.20 (s, 2H), 1.21-1.08 (m, 18H); ¹³C NMR (500 MHz, CDCl₃) δ: 174.1 (2C), 171.2 (2C), 57.6 (2C), 51.9 (2C), 51.6 (2C), 48.0 (2C), 37.6 (2C), 29.9 (2C), 29.4 (m, 6C), 27.0 (2C).

### Synthesis S4: Michael Addition of Trans-1,4-diaminocyclohexane to Dimethyl Maleate

A 250 mL 3-necked, glass, round bottom flask equipped with a magnetic stir bar was charged with trans-1,4-diaminocyclohexane (3.945 g, 34.2 mmol, from TCT America >98%) and methanol (38 mL). Gentle mixing was initiated, and the flask was equipped with a short-path distillation head with Vigreux column connected to an oil bubbler and fitted with a 50 mL collection flask. The still head was sealed to the center neck with silicone grease and the flask was further sealed with 1 rubber septum and an adapter to enable a nitrogen sweep. The flask was then cooled by submerging inside an ice water bath to absorb the heat of reaction. A thermocouple was inserted into the septum to track temperature during reaction. While under a nitrogen sweep to the still head, dimethyl maleate (10.110 g, 68.0 mmol, from TCI America 97%) was slowly added to the contents of the flask via syringe injection over 26 minutes. A minor exotherm was observed during the addition of dimethyl maleate. Once the temperature had stopped increasing, the flask was then placed in a heated water bath and stirred and allowed to reflux and distill for 4 hours. The resultant transparent orange solution was removed from the nitrogen and exposed to air and became turbid as precipitation began to occur. The precipitate was collected by partially removing methanol via rotary evaporation until a slightly viscous slurry formed and then this slurry was dried in a crystallization dish in a 50° C. oven for 16 hours. The resultant paste was determined to be the disubstituted adduct via ¹H and ¹³C NMR and was used without further purification. ¹H NMR (500 MHz, CDCl₃) δ 3.54-3.47 (m, 4H), 3.45 (s, 3H), 3.16 (s, 4H), 2.55-2.33 (m, 2H), 2.18 (tt, J=10.4, 3.6 Hz, 1H), 1.79-1.46 (m, 2H), 1.04-0.71 (m, 2H). ¹H NMR (500 MHz, CDCl₃) δ 174.3 (2C), 171.2 (2C), 51.7 (2C), 51.3 (2C), 38.0 (2C), 31.7 (1C), 31.5 (1C), 30.7 (1C), 30.4 (1C).

### Synthesis S5: Michael Addition of 1,7-Diaminoheptane to Dimethyl Maleate

A 100 mL 3-necked, glass, round bottom flask with a magnetic stirrer was charged with 1,7-diaminoheptane (4.5 g, 34 mmol, from Sigma Aldrich 98%) and ethanol (14 mL). Gentle mixing was initiated, and the flask was equipped with a cold-water condenser connected to an oil bubbler and sealed with silicone grease and 2 rubber septa. The flask was then cooled by submerging in an ice water bath in order to absorb the heat of reaction. A needle style thermocouple was inserted into one septum to track temperature during reaction. To the contents of the flask was slowly added dimethyl maleate (10.1 g, 68 mmol, from TCI America 97%) via a syringe. A great exotherm was observed during the addition of dimethyl maleate. The resulting solution was then placed on a block heater and stirred at 60° C. for five hours. Progress of the reaction was monitored by ¹H and ¹³C NMR spectroscopy. Upon complete conversion of amine to disubstituted adduct, ethanol was distilled off in a rotary evaporator to yield a slightly viscous light yellow adduct. ¹H NMR (500 MHz, CDCl₃) δ 3.62 (s, 6H), 3.57 (s, 6H), 3.52 (t, J=6.5 Hz, 2H), 2.62 (d, J=6.1 Hz, 1H), 2.59 (d, J=6.1 Hz, 1H), 2.56-2.47 (m, 4H), 2.36 (ddd, J=11.1, 7.9, 6.3 Hz, 2H), 1.40-1.25 (m, 4H), 1.24-1.12 (m, 7H); ¹³C NMR (500 MHz, CDCl₃) δ 174.1 (2C), 171.2 (2C), 57.6 (2C), 51.9 (2C), 51.7 (2C), 47.9 (2C), 37.7 (2C), 29.9 (2C), 29.1 (1C), 26,9 (2C).

### Synthesis S6: Michael Addition of 1,7-Diaminoheptane to Dimethyl Maleate

A 250 mL 3-necked, glass, round bottom flask with a magnetic stirrer was charged with 1,7-diaminoheptane (20.7 g, 155 mmol, from Sigma Aldrich 98%) and ethanol (50 mL). Gentle mixing was initiated, and the flask was equipped with a cold-water condenser connected to an oil bubbler and sealed with silicone grease and 2 rubber septa. The flask was then cooled by submerging in an ice water bath in order to absorb the heat of reaction. A needle style thermocouple was inserted into one septum to track temperature during reaction. To the contents of the flask was slowly added dimethyl maleate (46.1 g, 310 mmol, from TCI America 97%) via a syringe. A great exotherm was observed during the addition of dimethyl maleate. The resulting solution was then placed on a block heater and stirred at 60° C. for five hours. Progress of the reaction was monitored by ¹H and ¹³C NMR spectroscopy. Upon complete conversion of amine to disubstituted adduct, ethanol was distilled off in a rotary evaporator to yield a slightly viscous light yellow adduct. ¹³C NMR (500 MHz, CDCl₃) δ 174.09, 173.58, 171.22, 165.18, 133.27, 60.87, 57.77, 57.68, 57.59, 52.16 (d, J=4.1 Hz), 51.92, 51.68, 47.93, 37.66, 29.85, 29.12, 26.92, 18.28, 14.15-13.93 (m).

### Syntheses S7-S10: Preparation of Alkoxylate Polymers

In Syntheses S7-S10, alkoxylate polymers according to the formula CH₃O-(EO)ₘ(PO)ₙ—H having values of m and n as noted in TABLE 1 were prepared in a Symyx Parallel Pressure Reactor (PPR®) with a glass insert and equipped with removable polyether ether ketone (PEEK) paddle for mechanical stirring. Both the glass insert and the removable PEEK stir paddle was dried in a vacuum oven at 125° C. overnight prior to the reaction. An ethoxylated intermediate of type CH₃O-(EO)ₘ—H was prepared by ethoxylation of 2-methoxyethanol (from Sigma-Aldrich). A stock solution was prepared by dissolving in 2-methoxyethanol, under nitrogen, an amount of potassium hydride of about 3 wt % based on weight of the 2-methoxyethanol. Then a calculated amount of the stock solution was added to the glass insert under nitrogen. The glass insert was then loaded into a reactor, followed by attachment of the stirring paddle.

The reactor was then sealed, heated to 120° C., and pressurized with nitrogen to 345 kPa. Ethylene oxide was then delivered to the reactor in several injections via an Isco syringe pump equipped with a robotically controlled needle and compressed gas micro-valve connected to the reactor. The overall amount of ethylene oxide added to the reactor was calculated to provide the desired length of the (EO)ₙ block assuming complete consumption of the ethylene oxide added to the reactor. After addition of the ethylene oxide, the temperature was maintained at 120° C. and the reaction mixture was stirred for 4 hours. The reactor contents were then cooled. The reactor was vented and purged with nitrogen to remove any residual ethylene oxide.

The reactor was then heated to 50° C. and pressurized with nitrogen to a pressure of 345 kPa. Propylene oxide was then charged to the reactor via an Isco syringe pump. The amount of propylene oxide added to the reactor was calculated to correspond to the desired length of the (PO)ₙ block of the targeted material assuming complete consumption of the propylene oxide added to the reactor. After addition of the propylene oxide, the temperature was increased to 115° C. and maintained at that temperature while the contents of the reactor were stirred for 20 hours. The reactor contents were then cooled. The reactor was vented and purged with nitrogen to remove any residual ethylene oxide. The product from the reactor was used without further purification. The molecular weight of the product collected was determined by GPC and the composition was determined by quantitative ¹³C NMR as reported in Table 1.

TABLE 1

| | Calculated | | ¹³C NMR | | GPC | | |
|---|---|---|---|---|---|---|---|
| Ex. | m | n | m | n | Mn | Mw | PDI |
| S7 | 4.0 | 4.0 | 3.59 | 3.40 | 661 | 717 | 1.08 |
| S8 | 7.1 | 15.7 | 7.2 | 14.9 | 1,458 | 1,624 | 1.11 |
| S9 | 8.5 | 7.7 | 8.1 | 7.5 | 1,000 | 1,132 | 1.13 |
| S10 | 14.9 | 12.6 | 13.8 | 12.4 | 1,595 | 1,810 | 1.13 |

### Comparative Example C1: Preparation of Transesterification Product

In Comparative Example C1, a transesterification product of the following general formula

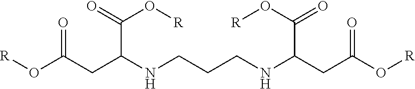

was prepared by charging an alkoxylate polymer (R—OH) (14.2490 g, 27.4 mmol, 4.4 eq., from The Dow Chemical Company as UCON™ 50-HB-100), material prepared according to Synthesis S1 (2.3113 g, 6.2 mmol) and titanium isopropoxide (0.234 g, 0.82 mmol, 13.2 mol %, from Sigma Aldrich 99.999%) to a 250 mL Airfree® Schlenk flask with a magnetic stir bar. The flask was sealed with a septum having a needle probe thermocouple inserted, attached to a Schlenk line, and then heated in an OptiTHERM® Reaction Block attached to an IKA magnetic heating plate with a set point temperature of 120° C. while under a nitrogen blanket. After 35 minutes, the temperature reached 118.3° C. and vacuum was applied to the flask contents via a mechanical pump with an intervening solvent trap housed inside a Dewar flask and submerged in a bed of dry ice. The mixing speed was adjusted from a setting of 200 to 300 rpm as the contents of the flask were heated to account for changes in viscosity. The flask contents were held at a temperature of 118.3-125.3° C. for seven hours under vacuum. The flask contents were then cooled and characterized by NMR to confirm completion of the reaction. Based on the ratio of total carbonyl carbon integral (peaks at 173.1, 170.2 ppm) to that of the residual methyl ester carbon peak at 51 ppm of ˜28:1, the extent of conversion of methyl ester is estimated to be >95%.

### Example 1: Preparation of Cleaning Booster

In Example 1, a transesterification product cleaning booster of the following general formula

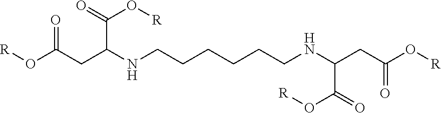

was prepared by charging an alkoxylate polymer (R—OH) (9.6139 g, 18.5 mmol, 4.6 eq., from The Dow Chemical Company as UCON™ 50-HB-100), material prepared according to Synthesis S2 (1.6793 g, 4.0 mmol) and titanium isopropoxide (0.142 g, 0.50 mmol, 12.5 mol %, from Sigma Aldrich 99.999%) to a 250 mL Airfree® Schlenk flask with a magnetic stir bar. The flask was sealed with a septum with a needle probe thermocouple inserted, attached to a Schlenk line, and then heated in an OptiTHERM® Reaction Block attached to an IKA magnetic heating plate with a set point temperature of 120° C. while under a nitrogen blanket. After 34 minutes, the temperature reached 112.7° C. and vacuum was applied to the flask contents via a mechanical pump with an intervening solvent trap housed inside a dewar flask and submerged in a bed of dry ice. The mixing speed was adjusted to 280 rpm. The flask contents were held at a temperature of 117.9-119.9° C. for nine hours under vacuum. The flask contents were then cooled and characterized by NMR to confirm completion of the reaction. Based on the ratio of total carbonyl carbon integral (peaks at 173.1, 170.2 ppm) to that of the residual methyl ester carbon peak at 51 ppm of >50:1, the extent of conversion of methyl ester is estimated to be >98%.

### Example 2: Preparation of Cleaning Booster

In Example 2, a transesterification product cleaning booster of the following general formula

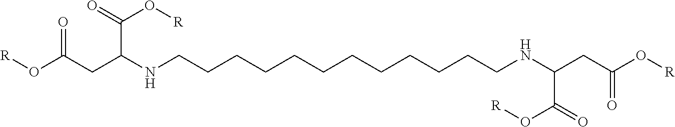

was prepared by charging an alkoxylate polymer (R—OH) (7.2037 g, 13.9 mmol, 4.5 eq., from The Dow Chemical Company as UCON™ 50-HB-100), material prepared according to Synthesis S3 (1.5627 g, 3.1 mmol) and titanium isopropoxide (0.191 g, 0.67 mmol, 21.6 mol %, from Sigma Aldrich 99.999%) to a 50 mL Airfree® Schlenk flask with a magnetic stir bar. The flask was sealed with a septum with a needle probe thermocouple inserted, attached to a Schlenk line, and then heated in an OptiTHERM© Reaction Block attached to an IKA magnetic heating plate with a set point temperature of 120° C. while under a nitrogen blanket. After 48 minutes, the temperature reached 90.5° C. and vacuum was applied to the flask contents via a mechanical pump with an intervening solvent trap housed inside a dewar flask and submerged in a bed of dry ice. The mixing speed was adjusted to 450 rpm. The flask contents were held at a temperature of 113.8-121.4° C. for five hours under vacuum. The flask contents were then cooled and characterized by NMR to confirm completion of the reaction. Based on the ratio of total carbonyl carbon integral (peaks at 173.0, 170.1 ppm) to that of the residual methyl ester carbon peak at 51 ppm of ˜29:1, the extent of conversion of methyl ester is estimated to be >95%.

### Example 3: Preparation of Cleaning Booster

In Example 3, a transesterification product cleaning booster of the following general formula

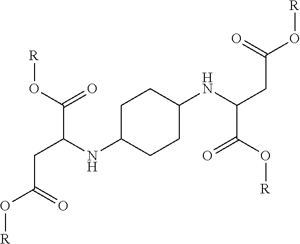

was prepared by charging an alkoxylate polymer (R—OH) (8.5855 g, 16.5 mmol, 4.3 eq., from The Dow Chemical Company as UCON™ 50-HB-100), material prepared according to Synthesis S4 (1.5268 g, 3.8 mmol) and titanium isopropoxide (0.180 g, 0.63 mmol, 16.6 mol %, from Sigma Aldrich 99.999%) to a 250 mL Airfree® Schlenk flask with a magnetic stir bar. The flask was sealed with a septum with a needle probe thermocouple inserted, attached to a Schlenk line, and then heated in an OptiTHERM® Reaction Block attached to an IKA magnetic heating plate with a set point temperature of 120° C. while under a nitrogen blanket. After 32 minutes, the temperature reached 118.3° C. and the sample turned from a hazy slurry to a clear solution. Vacuum was then applied to the flask contents via a mechanical pump with an intervening solvent trap housed inside a dewar flask and submerged in a bed of dry ice. The mixing speed was held constantly at 320 rpm. The flask contents were held at a temperature of 116.1-120.4° C. for 12.5 hours under vacuum. The flask contents were then cooled and characterized by NMR to confirm completion of the reaction. Based on the ratio of total carbonyl carbon integral (peaks at 173.7, 173.5, 171.1, 170.2, 170.1 ppm) to that of the residual methyl ester carbon peak at 51 ppm of ˜12:1, the extent of conversion of methyl ester is estimated to be about 90%.

### Example 4: Preparation of Cleaning Booster

In Example 4, a transesterification product cleaning booster of the following general formula

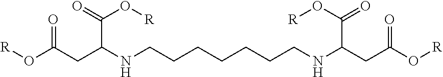

was prepared by charging an alkoxylate polymer (R—OH) (10.2631 g, 19.7 mmol, 4.4 eq., from The Dow Chemical Company as UCON™ 50-HB-100), material prepared according to Synthesis S5 (1.9334 g, 4.5 mmol) and titanium isopropoxide (0.1685 g, 0.59 mmol, 13 mol %, from Sigma Aldrich 99.999%) to a 250 mL flask with a magnetic stir bar and needle probe thermometer attached via a septum. The flask was sealed with silicone grease, purged with nitrogen and then heated in an OptiTHERM® Reaction Block attached to an IKA magnetic heating plate with a set point temperature of 120° C. After the contents of the flask reach an internal temperature of 120° C., vacuum was applied to the flask contents via a mechanical pump with an intervening solvent trap cooled via dry ice in a dewar flask. The mixing speed setting was constant at 230 rpm as the contents of the flask maintained constant viscosity for duration of heating. The flask contents were held at a temperature of 119-121° C., for eight and a half hours under vacuum. The flask contents were then cooled and characterized. The extent of displacement of methyl ester groups was estimated by the integrated peaks in the quantitative 13C NMR spectra for the methyl groups of the methyl ester (51.5 ppm) and the α-methylene group (38.1 ppm) on the heptanediamine-dimethyl maleate adduct. This ratio was 0.12:1, and since the original unreacted heptanediamine-dimethyl maleate adduct has a methyl ester: α-methylene ratio of 2.18:1, this would suggest that ˜94% of the methyl groups had been converted.

### Example 5: Preparation of Cleaning Booster

In Example 5, a transesterification product cleaning booster of the following general formula

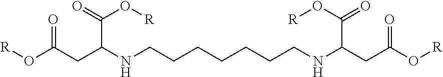

was prepared by charging the alkoxylate polymer product of Synthesis S7 (R—OH) (42.6 g, 110 mmol, 5.7 eq.) to a 250 mL Chemglass Airfree® flask with a magnetic stir bar and needle probe thermometer attached via a septum. The flask was sealed with silicone grease, purged with nitrogen and then heated in an OptiTHERM® Reaction Block attached to an IKA magnetic heating plate with a set point of 400 rpm at room temperature. After mixing was initiated, vacuum was applied via mechanical pump with intervening solvent trap cooled by a bed of dry ice. After 1 hour of vacuum stripping, the flask was disconnected from vacuum source and refilled with nitrogen. The product of Synthesis S6 (8.2913 g, 19.4 mmol), and titanium isopropoxide (0.9364 g, 3.29 mmol, 17 mol %, from Sigma Aldrich 99.999%) were added to the flask and the flask was resealed with a septum. The flask was then heated and stirred with a set point temperature of 120° C. and 400 rpm. After 1 hours of heating and mixing, vacuum was applied for 7 hours with a final reduced pressure of 0.1 Torr. The product was cooled and characterized using NMR. ¹³C NMR revealed 100% conversion of methyl ester to the tetrasubstituted product. ¹³C NMR (126 MHz, CDCl₃) δ 75.87-74.12 (m), 73.54-72.30 (m), 72.00-70.98 (m), 70.77-69.23 (m), 58.89, 17.43-15.75 (m).

### Examples 6-8: Preparation of Cleaning Boosters

In Examples 6-8, a transesterification product cleaning booster of the following general formula

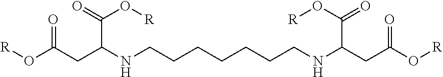

was prepared by charging the alkoxylate polymer of the type and in the amount noted in Table 2 to a 250 mL Chemglass Airfree® flask with a magnetic stir bar and needle probe thermometer attached via a septum. The flask was sealed with silicone grease, purged with nitrogen and then heated in an OptiTHERM® Reaction Block attached to an IKA magnetic heating plate with a set point of 400 rpm at room temperature. After mixing was initiated, vacuum was applied via mechanical pump with intervening solvent trap cooled by a bed of dry ice. After 1 hour of vacuum stripping, the flask was disconnected from vacuum source and refilled with nitrogen. The product of Synthesis S6 and titanium isopropoxide (from Sigma Aldrich 99.999%) in the amount noted in Table 2 was added to the flask and the flask was resealed with a septum. The flask was then heated and stirred with a set point temperature of 120° C. and 400 rpm. After 1 hours of heating and mixing, vacuum was applied for 7 hours with a final reduced pressure of 0.1 Torr. The product was collected.

TABLE 2

| | | Example | | |
|---|---|---|---|---|
| Reagent | | 6 | 7 | 8 |
| alkoxylate | Synthesis S8 | 4.88 | 0 | 0 |
| polymer | Synthesis S9 | 0 | 4.49 | 0 |
| | Synthesis S10 | 0 | 0 | 4.60 |

| | | | |
|---|---|---|---|
| Synthesis S6 | 0.39 | 0.58 | 0.45 |
| Titanium isopropoxide | 0.036 | 0.070 | 0.044 |

### Comparative Examples CF1-CF3 and Examples F1-F3: Liquid Laundry Detergent

The liquid laundry detergent formulations used in the cleaning tests in the subsequent Examples were prepared having the generic formulation as described in TABLE 3 with the cleaning booster as noted in TABLE 4 neutralized to a pH of 8.5 were prepared by standard liquid laundry formulation preparation procedures.

TABLE 3

| Ingredient | Commercial Name | wt % |
|---|---|---|
| Linear alkyl benzene sulfonate | Nacconal 90G* | 12.0 |
| Sodium lauryl ethoxysulfate | Steol CS-460* | 3.0 |
| Propylene glycol | — | 3.0 |
| Ethanol | — | 1.2 |
| Sodium citrate | — | 1.0 |
| Sodium xylenesulfonate | Stepanate SXS-93 | 3.3 |
| Fatty acid | Prifac 7908^{a} | 1.8 |
| Cleaning Booster | — | 5.0 |
| Deionized water | — | QS to 100 |

*from Stepan Company
^{a}from Croda

TABLE 4

| Example | Cleaning Booster |
|---|---|
| Comparative Example CF1 | Alcohol ethoxylate¹ |
| Comparative Example CF2 | Ethoxylated poly(ethyleneimine)² |
| Comparative Example CF3 | Comparative Example C1 |
| Example F1 | Example 1 |
| Example F2 | Example 2 |
| Example F3 | Example 3 |

¹from Stepan Company under the tradename BIO-SOFT ® N25-9
²from BASF under tradename SOKOLAN ™ HP-20

### Primary Cleaning Performance

The primary cleaning performance of the liquid laundry detergent formulations of Comparative Examples CF1-CF2 and Examples F1-F3 were assessed in a Launder-Ometer (SDL Atlas, Model M228AA) at a set test temperature of 22° C. using an 18 minute wash cycle. Twenty of the 1.2 liter canisters were filled with 500 mL of hardness adjusted water at 100 ppm by mass with 2:1 Ca²⁺:Mg²⁺ molar ratio were used for each run. The washed fabrics were rinsed in 300 mL of 100 ppm (2/1 Ca²⁺/Mg²⁺) hardness adjusted water at ambient temperature for 5 minutes at 260 osc/min pm on an Eberbach E6000 reciprocal shaker. The stained fabrics and soiled ballasts used in the tests were PCS-S-132 high discriminative sebum BEY pigment and PCS-S-94 sebum/dust ASTM stains from Testfabrics stitched to a pre-shrunk cotton interlock fabric. The size of the cotton interlock was 5×5 cm. The stained swatches were 2.5×3 cm. One 5×5 cm cut SBL-CFT soil ballast was added to each canister to provide baseline soil to the wash solution. The total surfactant concentration in the wash liquor was 200 ppm.

### Reflectance Measurement and Stain Removal Index (SRI)

The soil removal index (SRI) for each of the Liquid Laundry Detergent formulations evaluated in Primary Cleaning Performance Test were determined using ASTM Method D4265-14. The average SRI taken from 8 swatches per condition (two swatches per pot, 4 pots) is provided in TABLE 5.

The L*, a* and b* values of the stained fabrics were measured pre and post wash with a Mach 5 spectrophotometer from Colour Consult. The L % a* and b* values for the unwashed, unstained polycotton fabric was measured in the SRI calculations as follows:

$$S R I = \frac{( Δ {E}_{( U S - U F )}^{*} - Δ {E}_{( W S - U F )}^{*}}{Δ {E}_{( US - UF )}^{*}} \times 100$$

wherein US is the unwashed stain area, UF is the unwashed (unstained) fabric area, WS is the washed stain area, ΔE*_{(US-UF)} is the ΔE* color difference between the unwashed stain and the unwashed fabric and ΔE*_{(WS-UF)} is the ΔE* color difference between the washed stain and the unwashed fabric. The value of ΔE* is calculated as

$$Δ E * = {( Δ {L}^{* 2} + Δ {a}^{* 2} + Δ {b}^{* 2} )}^{1 / 2}$$

The ΔSRI values provided in TABLE 5 give the difference between the SRI measured for the noted example relative to the SRI measured for Comparative Example CF1. A positive value indicates an increase in soil removal relative to Comparative Example CF1.

TABLE 5

| | | ΔSRI | |
|---|---|---|---|
| Example | Cleaning Booster | PCS-94 | PCS-132 |
| Comparative | Ethoxylated | −0.6 | −3.2 |
| Example CF2 | poly(ethyleneimine)¹ | | |
| Comparative | Comparative Example C1 | 1.01 | 4.79 |
| Example CF3 | | | |
| Example F1 | Example 1 | 2.21 | 3.92 |
| Example F2 | Example 2 | 2.6 | 2.12 |
| Example F3 | Example 3 | 1.8 | 4.25 |

¹from BASF under tradename SOKOLAN ™ HP-20

### Comparative Examples CF4-CF6 and Examples F4-F6: Liquid Laundry Detergent

The liquid laundry detergent formulation of Comparative Examples CF4-CF6 and Examples F4-F6 used in the subsequent cleaning tests were prepared by combining 0.5 g of a standard liquid laundry detergent formulation with an adjusted pH of 8.5 as described in TABLE 6 with 1.5 g of a 1 w % aqueous solution of the cleaning booster noted in TABLE 7.

TABLE 6

| Ingredient | Commercial Name | wt % |
|---|---|---|
| Linear alkyl benzene sulfonate | Nacconal 90G* | 12 |
| Sodium lauryl ethoxysulfate | Steol CS-460* | 2 |
| Propylene glycol | — | 3.5 |
| Ethanol | — | 1.5 |
| Deionized water | — | QS to 100 |

*from Stepan Company
^{a} from The Dow Chemical Company

TABLE 7

| Example | Cleaning Booster |
|---|---|
| Comparative Example CF4 | None |
| Comparative Example CF5 | Ethoxylated poly(ethyleneimine)¹ |
| Comparative Example CF6 | Comparative Example C1 |
| Example F4 | Example 1 |
| Example F5 | Example 2 |
| Example F6 | Example 3 |

¹from BASF under tradename SOKOLAN ™ HP-20

### Anti-Redeposition

The anti-redeposition performance of the combination of the standard liquid laundry detergent+cleaning booster of Comparative Examples CF4-CF6 and Examples F4-F6 was assessed in a Terg-o-tometer Model 7243ES agitated at 90 cycles per minute with the conditions noted in TABLE 8.

TABLE 8

| Parameter | Setting |
|---|---|
| Temperature | 50° C. |
| Water hardness | 300 ppm, Ca²⁺/Mg²⁺ = 2/1 |
| Fabric Types | Cotton (C) |
| | Cotton interlock (CI) |
| | Cotton Terry (CT) |
| | Polyester: cotton blend (PB) |
| | Polyester knit (PK) |
| | Polyester woven (PW) |
| | two cloths of each type in each pot |
| Wash time | 60 minutes |
| Rinse time | 3 minutes |
| Liquid laundry detergent | 0.5 g |
| dosage | |
| Cleaning booster | 1.5 g of 1 wt % aqueous solution |
| Anti-redeposition soils | 2.5 g/L dust sebum |
| | 0.63 g/L Redart clay |
| Drying | After final rinse, fabrics were dried in a food |
| | dehydrator at 50° C. for 2 hours |

The antiredeposition performance was determined by calculating the ΔE measured with a MACH 5+ instrument (L, a & b). The results are noted in TABLE 9, wherein ΔE* is according to the equation

$$Δ E * = Δ {E}_{a w} - Δ {E}_{b w}$$

wherein ΔE_{aw} is measured from fabrics after washing, and ΔE_{bw} is measured from fabrics before washing. A higher ΔE* corresponds with better antiredeposition performance.

TABLE 9

| | ΔE* | | | | | |
|---|---|---|---|---|---|---|
| Example | C | CI | CT | PB | PK | PW |
| Comp. Ex. CF4 | 13.16 | 20.79 | 21.38 | 13.61 | 25.31 | 17.20 |
| Comp. Ex. CF5 | 9.49 | 13.48 | 12.86 | 8.46 | 19.67 | 12.33 |
| Comp. Ex. CF6 | 7.63 | 13.23 | 13.85 | 11.83 | 24.93 | 16.06 |
| Example F5 | 7.33 | 11.90 | 14.43 | 12.81 | 25.66 | 15.42 |
| Example F6 | 8.05 | 12.03 | 13.04 | 13.28 | 27.67 | 17.43 |
| Example F7 | 8.99 | 14.25 | 14.47 | 12.63 | 25.82 | 15.83 |

### Comparative Examples CF7-CF8 and Examples F8-F11: Unit Dose Laundry Detergent

Unit dose laundry detergent formulations of Comparative Examples CF7-CF8 and Examples F8-F11 used in the subsequent cleaning tests were prepared having the generic formulation as described in TABLE 10 with the cleaning booster as noted in TABLE 11 neutralized to a pH of 8.5 were prepared by standard laundry formulation preparation procedures.

TABLE 10

| Ingredient | Commercial Name | wt % |
|---|---|---|
| 4-Dodecylbenzenesulfonic acid | Product No. 44198^{a} | 30 |
| Sodium lauryl ethoxysulfate | Steol CS-460^{b} | 10 |
| Propylene glycol | — | 19 |
| Monoethanolamine | Monoethanolamine (MEA)^{c} | 8 |
| Glycerin | — | 19 |
| Oleic acid | — | 3 |
| Cleaning booster | — | 5 |
| Deionized water | — | QS to 100 |

^{a}from Sigma Aldrich
^{b}from Stepan Company
^{c}from The Dow Chemical Company

TABLE 11

| Example | Cleaning Booster |
|---|---|
| Comparative Example CF7 | Alcohol ethoxylate¹ |
| Comparative Example CF8 | Ethoxylated poly(ethyleneimine)² |
| Example F8 | Example 5 |
| Example F9 | Example 6 |
| Example F10 | Example 7 |
| Example F11 | Example 8 |

¹from Stepan Company under the tradename BIO-SOFT ® N25-9
²from BASF under tradename SOKOLAN ™ HP-20

### Primary Cleaning Performance

The primary cleaning performance of the unit dose formulations of Comparative Examples CF7-CF8 and Examples F8-F11 was assessed in a Terg-O-Tometer Model 7243ES with canisters (2 L) agitated at 85 cycles per minute with the conditions noted in TABLE 12.

TABLE 12

| Parameter | Setting |
|---|---|
| Temperature | 30° C. |
| Water hardness | 120 ppm, Ca²⁺/Mg²⁺ = 3/1 |
| Water volume | 1 L per cannister |
| Fabric/Soil | 2 inch × 2 inch square cut PC-S-94 dust |
| | sebum swatches from Testfabrics |
| Wash time | 30 minutes |
| Rinse time | 3 minutes |
| detergent dosage | 0.3 g/L |
| Drying | After final rinse, fabrics were dried in a food |
| | dehydrator at 50° C. for 2 hours |

### Reflectance Measurement and Stain Removal Index (SRI)

The soil removal index (SRI) for each of the Liquid Laundry Detergent formulations evaluated in Primary Cleaning Performance Test were determined using ASTM Method D4265-14. The average SRI taken from 8 swatches per condition (two swatches per pot, 4 pots) is provided in TABLE 13.

The L*, a* and b* values of the stained fabrics were measured pre and post wash with a Mach 5 spectrophotometer from Colour Consult. The L*, a* and b* values for the unwashed, unstained fabric was measured in the SRI calculations as follows:

$$S R I = \frac{( Δ {E}_{( U S - U F )}^{*} - Δ {E}_{( W S - U F )}^{*}}{Δ {E}_{( US - UF )}^{*}} \times 100$$

wherein US is the unwashed stain area, UF is the unwashed (unstained) fabric area, WS is the washed stain area, ΔE*_{(US-UF)} is the ΔE* color difference between the unwashed stain and the unwashed fabric and ΔE*_{(WS-UF)} is the ΔE* color difference between the washed stain and the unwashed fabric. The value of ΔE* is calculated as

$$Δ E * = {( Δ {L}^{* 2} + Δ {a}^{* 2} + Δ {b}^{* 2} )}^{1 / 2}$$

TABLE 13

| | | ΔSRI |
|---|---|---|
| Example | Cleaning Booster | PCS-94 |
| Comparative Example CF7 | Alcohol ethoxylate¹ | 36.4 |
| Comparative Example CF8 | Ethoxylated poly(ethyleneimine)² | 31.0 |
| Example F8 | Example 5 | 45.9 |
| Example F9 | Example 6 | 47.2 |
| Example F10 | Example 7 | 43.9 |
| Example F11 | Example 8 | 41.4 |

¹from Stepan Company under tradename BIO-SOFT ® N25-9
²from BASF under tradename SOKOLAN ™ HP-20

We claim:

1. A cleaning booster for cleaning dirty laundry, wherein the cleaning booster is of formula (I)
R¹-A¹-R¹ (I)
wherein A¹ is a divalent linking group having 4 to 24 carbon atoms; and wherein each R¹ is independently selected from the group consisting of formula (II), formula (III) and formula (IV) 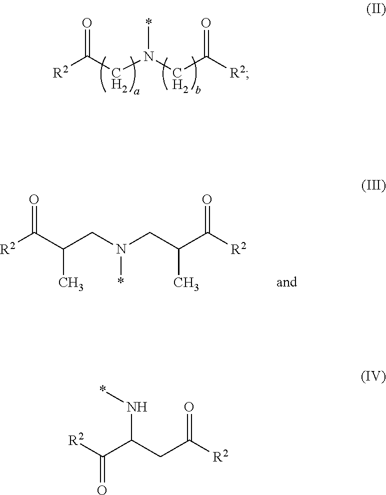
wherein the * in formula (II), formula (III) and formula (IV) is the point of attachment to formula (I); wherein a is 1 or 2; wherein b is 1 or 2; and wherein each R² is independently of formula (V) 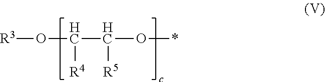
wherein the * in formula (V) is the point of attachment to the associated base formula;
wherein R³ is selected from the group consisting of a hydrogen and a C₁₋₂₂ alkyl group;
wherein each R⁴ and R⁵ is independently selected from the group consisting of a hydrogen and a C₁₋₂ alkyl group, with the proviso that at least one of R⁴ and R⁵ is a hydrogen in each subunit c; and wherein c is 0 to 30; and with the proviso that when the divalent linking group, A¹, has 4 carbon atoms, the divalent linking group, A¹, includes a cycle.

2. The cleaning booster of claim 1, wherein the cleaning booster of formula (I) is of formula (Ia)
R—(CH₂)ₙ—R¹ (Ia)
wherein n is 5 to 24.

3. The cleaning booster of claim 1, wherein the cleaning booster of formula (I) is of formula (Ib) 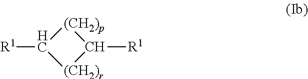
wherein p and r are independently 1 to 4.

4. The cleaning booster of claim 1, wherein the cleaning booster of formula (I) is of formula (Ic) 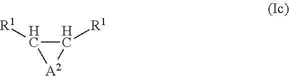
wherein A² is a divalent linking group having 2 to 22 carbon atoms.

5. The cleaning booster of claim 1, wherein the cleaning booster of formula (I) is of formula (Id) 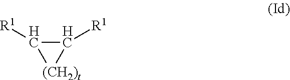
wherein t is 2 to 10.

6. The cleaning booster of claim 1, wherein c is 2 to 30 in 70 to 100 mol % of the occurrences of R² in the cleaning booster.

7. The cleaning booster of claim 1, wherein 70 to 100 mol % of the R² groups in the cleaning booster are of formula (Va)
R⁶—O—[CH₂CH(R⁷)O]_{y}—* (Va)
wherein the * in formula (Va) is the point of attachment to the associated base formula;
wherein R⁶ is selected from the group consisting of a hydrogen and a C₁₋₂₂ alkyl group;
wherein each R⁷ is independently selected from the group consisting of a hydrogen and a C₁₋₂ alkyl group; and wherein y is 2 to 30.

8. The cleaning booster of claim 1, wherein 70 to 100 mol % of the R² groups in the cleaning booster are of formula (Vb)
R⁸—O-(EO)ₕ—(PO)ᵢ-(EO)ⱼ—* (Vb)
wherein the * in formula (Vb) is the point of attachment to the associated base formula;
wherein R⁸ is selected from the group consisting of a hydrogen and a C₁₋₂₂ alkyl group;
wherein EO is an ethylene oxide group; wherein PO is a propylene oxide group; wherein h is 0 to 30; wherein i is 0 to 30; wherein j is 0 and 30; and wherein h+i+j is 2 to 30.

9. A laundry additive comprising a mixture of a cleaning booster of claim 1 and water.

10. The laundry additive of claim 9, wherein the laundry additive is a liquid.
